(19) United States
(12) Patent Application Publication
(10) Pub. No.: US 2006/0254404 A1
(43) Pub. Date: Nov. 16, 2006

(54) System and method for teaching guitar lessons

(75) Inventors: John Bryant, Orlando, FL (US); Mark Hara, Maitland, FL (US)

Correspondence Address: BEUSSE WOLTER SANKS MORA & MAIRE, P. A., 390 NORTH ORANGE AVENUE, SUITE 2500, ORLANDO, FL, 32801, US

(73) Assignee: Talking Tabs, LLC

(21) Appl. No.: 11/125,786

(22) Filed: May 10, 2005

(51) Int. Cl. G10F 1/02

(52) U.S. Cl. 84/47

(57) ABSTRACT

A system and method of teaching guitar lessons that includes a step of recreating a song at a reduced tempo from its original recording. Each note and/or chord of a particular measure of a song is played at the reduced tempo, then the measure is played and then the entire song section is played. The notes or chords are preferably verbally communicated using a tablature method that identifies the fingers using an index I (index finger), M (middle finger), R(ring finger) and P(pinkie finger). The lesson may be recorded on a medium such as tape, cassette, compact disc or made available for downloading via the Internet. At the end of the lesson a recording of the song is provided with the guitar portion is removed so a student may play the guitar portion of the song.

### FIELD OF THE INVENTION

This invention relates generally to musical instruction. More specifically, the invention pertains to methods or systems used to teach one how to play a stringed instrument such as a guitar.

### BACKGROUND OF THE INVENTION

A method used for teaching and/or learning how to play a stringed instrument includes the use of printed tablature. Tablature is an instrumental notation indicating the string, fret, key or finger to be used instead of the tone to be sounded. A tablature notates music as a series of playing positions. A tablature for a stringed instrument guides the student's fingers to the string that must be plucked and the fret at which the string is stopped. Such tablatures are published in manuals or instructional videos.

A guitar tablature is shown in FIG. 1, and includes a six-line staff that graphically represents the guitar fingerboard, with the top line indicating the highest sounding string (high E). By placing a number on the appropriate line, the string and fret of any note can be indicated. The number 0 represents an open string. The 0's mean that the string is played open (no finger) and the other numbers indicate which fret you place your finger on. However, such tablature typically identifies the finger with a number, which can be confusing when to referring to a fret identified with same number. Moreover, some tablatures do not include the identification of the particular finger to be used, and it is left to the student to determine which finger should be used to contact a string.

### SUMMARY OF THE INVENTION

The present invention is for a system and method for teaching guitar lessons. In accordance with the present invention, the guitar lesson is entirely verbal without reference to printed music or tablature diagrams. A guitar portion of the song is selected and recreated at a reduced tempo in comparison to an original recording of the song. The song is divided into its various sections such as the introduction, verses and chorus, which typically comprise one or measures. Each measure includes one or more chords, which have at least two notes.

As to each section each note of each chord is identified by verbally communication of the note tablature. The tablature assigns the letters I, M, R and P for the respective index, middle, ring and pinkie finger of the hand. Guitar strings are identified with their respective letter, and frets are identified with a number.

Each note is played on the guitar in accordance with the reduced tempo of the song, and then the chord is played after all the notes have been identified and played. After all the chords of a measure have been identified and played, the entire measure is played. This process is completed for all the measures of a particular section. Then the section is played at the reduced tempo. The section may be played at the reduced tempo before the tablature identification of the notes as an introduction to that portion of the lesson. All sections and measures are taught in this manner in the order in which they appear in the song.

The lesson may be recorded on available medium such as tape cassette, compact disc etc., or made available for downloading via the Internet, or transmitted via a radio signal. A recording of the song with the guitar portions removed may be included so a student can play the guitar portion of song with the recording.

### BRIEF DESCRIPTION OF THE DRAWINGS

FIG. 1 is a prior art tablature display.

FIG. 2 is a perspective view of a guitar neck.

FIG. 3 is an illustration of two measures of a song.

### DETAILED DESCRIPTION

The present invention for a novel instructional system and method for teaching a person how to play a guitar utilizes solely audio instructions without the need of diagrams, instructional manuals or the like. The lesson may also be utilized in a live guitar lesson. The lesson may be recorded on any appropriate medium such as a cassette tape, compact disc, or may be downloaded if provided via the Internet, or transmitted via a radio signal. The system and method incorporates tablature method for identifying notes and chords which tablatures are verbally communicated via the chosen medium or in person.

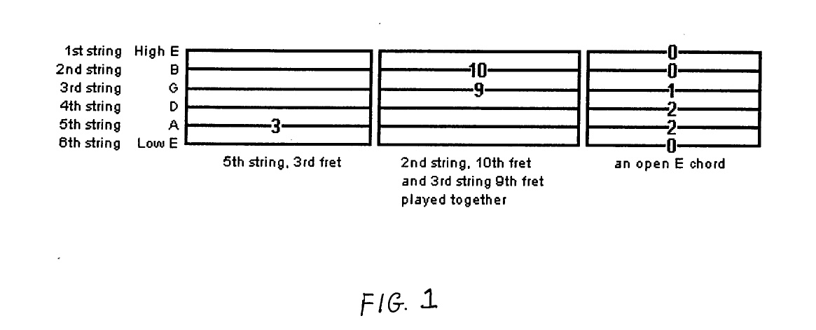

The present invention is not limited to a six-string guitar depicted in FIG. 1, but may be used in lessons involving any stringed instrument, and especially such instruments having frets.

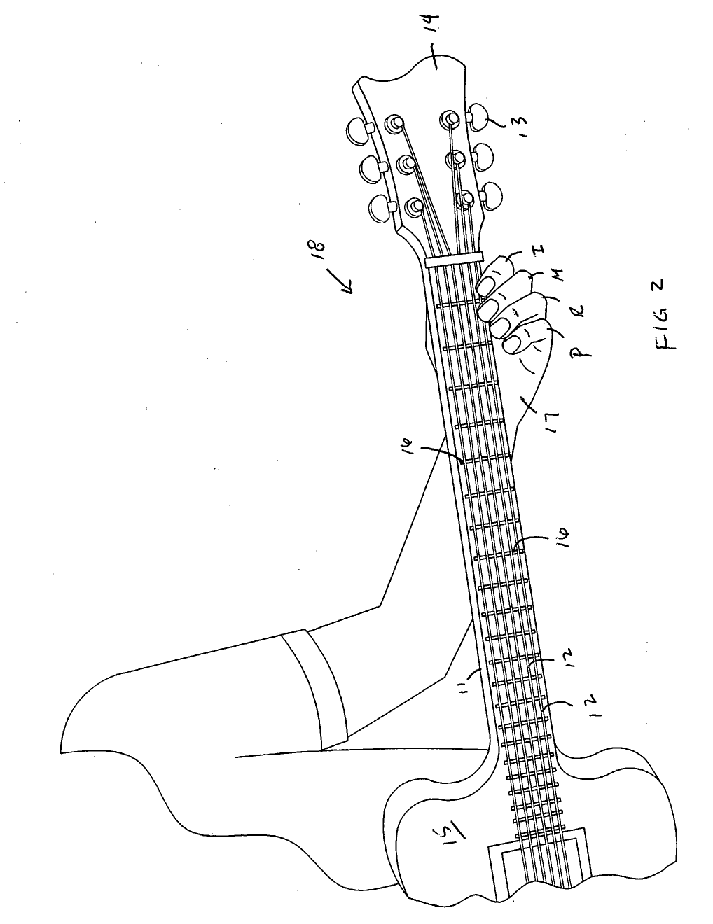

The instructor identifies each note for each chord by identifying the string or strings involved, the finger necessary to contact the identified strings and the fret on the guitar on which the finger is placed. A neck 11 of a six-string guitar 18 is illustrated in FIG. 2. Strings 12 are secured the tuning pegs 13 on the headstock 14 at one end of the strings and to the body 15 of the guitar 18 at the other end of the strings 12. Frets 16 are positioned along the neck 11 of the guitar 18 and serve as locators for positioning an artist or students fingers on the string 12 and neck 11 of the guitar 18 for playing notes or chords. Typically guitars have from twenty-one to twenty-four frets. Each of the strings is identified with a respective letter e, B, G, D, A or E, which letters also represent a song note or pitch.

With respect to the present invention, notes or chords from a song are identified using a tablature system that identifies the string or strings on the guitar to be contacted, the particular finger used to contact the string and the fret on or about which the finger is placed. The note tablature is verbally communicated from the instructor who then plays each note at the correct pitch of the note for the correct count or duration of the note. Then the instructor plays the entire chord including all the notes of the chord, at the correct pitch and count or duration of the chord.

With respect to the tablature system of the present invention, each fret 16 is assigned a number for identification of the fret during the lesson. For example with respect to FIG. 2, the guitar neck has twenty-two frets which are respectively assigned numbers 1 through 22 beginning from the neck 11 of the guitar and counting all the frets on the neck 11 to the body 15 of the guitar. The fingers on a student's hand 17, as shown in FIG. 2, is assigned a letter that represents a respective finger and does not conflict with the musical alphabet A, B, C, D, E, F, G or to the letters assigned to the guitar strings. In an exemplary embodiment of the invention, the letters used to identify the fingers are I, M, R and P wherein the letter I represents the index finger, the letter M represents the middle finger, the letter R represents the ring finger and the letter P represents the pinkie finger.

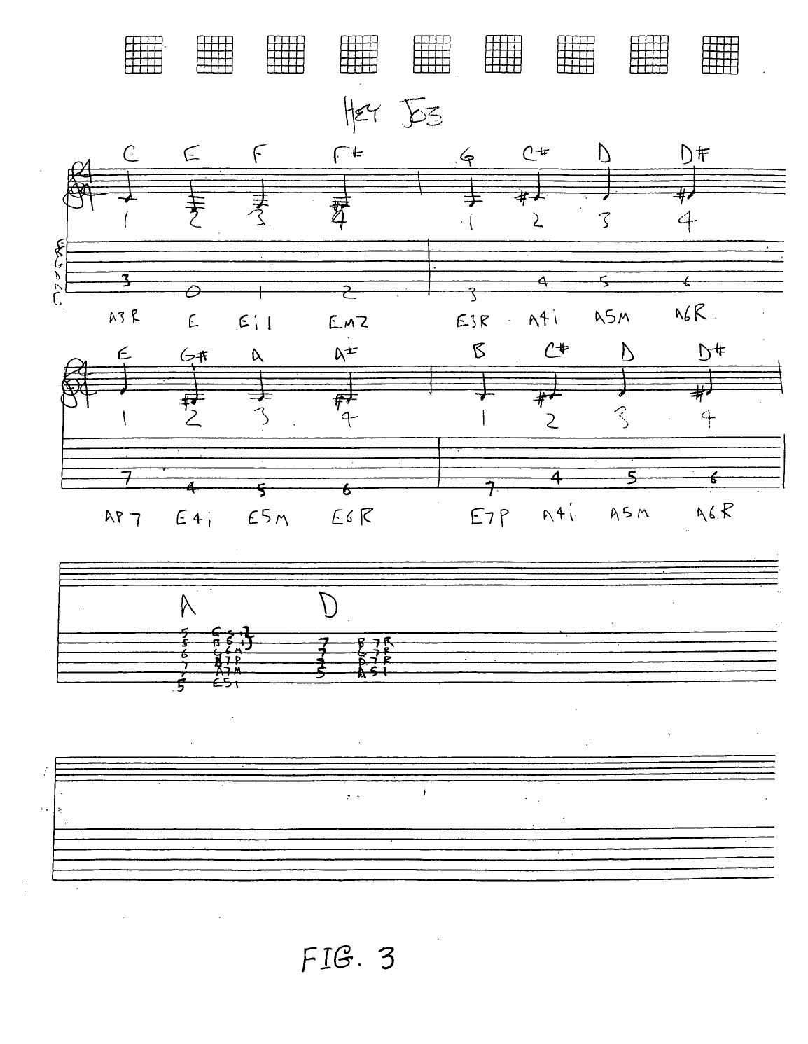

The instructor verbally conveys the note in tablature form including the letter tab for the string, letter tab for the respective finger and the fret number. For example a note may be verbally communicated as “EM8”, or any combination of these three tabs, which instructs the student that the middle finger is placed on the E string at the eighth fret on the guitar neck. With respect to FIG. 3, two guitar chords are shown on a measure including four musical notes in each chord. Reading the measure from left to right the first chord includes notes C, E, F and F sharp (F#) and are set forth in the below table:

| Note | Tab | Finger Placement |
|---|---|---|
| C | AR3 | string A, ring finger on third fret |
| E | E | string E, open (no fretting) |
| F | EI1 | E string, index finger on the first fret |
| F# | EM2 | E string, middle finger on the second fret |

The second chord includes notes G, C sharp (C#), D and D sharp (D#), and are set forth in tablature form in the table below:

| Note | Tab | Finger Placement |
|---|---|---|
| G | ER3 | E string, ring finger on third fret |
| C# | AI4 | A string, index finger on the fourth fret |
| D | AM5 | A string, middle finger on the fifth fret |
| D# | AR6 | A string, ring finger on sixth fret |

In an exemplary embodiment, the instructor plays each note and simultaneously verbally communicates each of the notes in unison pitch and note duration to augment the instrument's note. Thus the verbal communication, in the abbreviated tab form of the note is synchronized with the instrument note as the instructor plays the note.

With respect to the lesson itself, a particular song is chosen for a lesson. The guitar portion of the song is recreated, played and recorded at a reduced tempo so the student may more clearly hear each note and each chord. For example, a song that may normally be played at 106 beats per minute may be recorded at 60 beats per minute. A click track may be incorporated with the recreated song recording to assist the student and instructor with maintaining the tempo of the song.

The different sections of the song are identified. For example, a song typically includes an introduction, chorus and verse; however, a song may have fewer or more sections. As to each section of the song, the instructor identifies each note of each chord for every measure in the song, instructing a student the appropriate placement of the student's fingers a string and/or fret using the above described tablature.

In an exemplary embodiment, the recreated version of a particular section of the song is played in its entirety. For example, a verse of a song is played. Then the instructor identifies the number of measures in the song section, and as to each measure the instructor communicates each note and/or chord a measure at a time. For example, with respect to a verse having four measures, the instructor will begin with the first measure and identify each note for each chord using the above-described tablature, and play each note at its correct pitch and duration as played in the recreated version of the song. After each of the notes is identified and played, the instructor plays the entire chord. This exercise is completed for all the chords of the first measure. Then the instructor plays all the chords for the first measure at the reduced tempo of the recreated song.

The instructor then moves on to the second measure identifying and playing the notes and chords using the same procedure as in the first measure. The instructor then plays the chords of the second measure, and then plays the first measure and second measure in order. This exercise is followed for each of the four measures. After completing all four measures, the instructor then plays all four measures of the verse at the correct tempo and pitch of the recreated song. The above described method and system is repeated for each section of the song in the identical order in which the sections are played in the song.

In an exemplary embodiment, at the end of the recorded version of the lesson, a recorded version of the song is provided with one or more of the guitar portions eliminated or removed from the recording so the student can play along with recording.

While the preferred embodiments of the present invention have been shown and described herein, it will be obvious that such embodiments are provided by way of example only and not of limitation. Numerous variations, changes and substitutions will occur to those of skilled in the art without departing from the teaching of the present invention. Accordingly, it is intended that the invention be interpreted within the full spirit and scope of the appended claims.

We claim as our invention:

1. A method for teaching a guitar lesson, comprising the steps of:
selecting a song having one or more guitar portions, and one or more sections wherein each section of the song has one or more measures, and each of the measures having one or more chords comprising two or more notes;
recreating the one or more guitar portions of the song at a reduced tempo in comparison to a tempo of an original recording of the song;
identifying each note of each chord in each measure of the song, in the order in which the measures and sections appear in the song, using tablature to identify placement of a student's finger with respect to a guitar string and a fret;
playing the note in accordance with the reduced tempo;
playing the chord in accordance with reduced tempo, after identifying and playing all the notes of the chord;
playing the measure in accordance with reduced tempo, after identifying and playing all notes and all chords of the measure;
playing the section of the song at the reduced tempo after identifying and playing each chord of each measure the section; and,

2. The method of claim 1 wherein the note tablature used comprises the steps of identifying the index finger with the letter I, the middle finger with the letter M, the ring finger with the letter R, or the pinkie finger with the letter P, identifying each guitar string with the appropriate guitar string letter and identifying a fret on the guitar with a number.

3. The method of claim 2 further comprising the step of verbally communicating the note tablature to a student in accordance with the reduced tempo while playing the note.

4. The method of claim 1 further comprising the step of providing a recording of the song wherein the guitar portion is removed so a student can play the guitar portion with the remaining instrument portion of the song.

5. The method of claim 1 further comprising the step of playing a section of the song before the tablature identification of all the notes and before playing the notes and chords of the song.

6. A method for teaching a guitar lesson, comprising the steps of:
selecting a song having one or more guitar portions, and one or more sections wherein each section of the song has one or more measures, and each of the measures having one or more chords comprising two or more notes;
selecting a reduced tempo at which to play the song in comparison to a tempo of an original recording of the song;
for each section, identifying each note of each chord in each measure of the song, in the order in which the measures and sections appear in the song, using tablature to identify placement of a student's finger with respect to a guitar string and a fret;
playing the note in accordance with the reduced tempo of the song, after the tablature identification of the note;
playing the chord in accordance with reduced tempo, after identifying and playing all the notes of the chord; and,
playing sections of the song at the reduced tempo in comparison to a tempo of an original recording of the song, before or after the tablature identification of the notes and playing the notes.

7. The method of claim 7 further comprising the step of playing the measure in accordance with reduced tempo, after identifying and playing all notes and all chords of the measure.

8. The method of claim 7 further comprising the step of providing a recording of the song wherein the guitar portion is removed so a student can play the guitar portion with the remaining instruments of the song.

9. The method of claim 7 wherein the note tablature used comprises the steps of identifying the index finger with the letter I, the middle finger with the letter M, the ring finger with the letter R, or the pinkie finger with the letter P, identifying each guitar string with the appropriate guitar string letter and identifying a fret on the guitar with a number.

10. The method of claim 2 further comprising the step of verbally communicating the note tablature to a student in accordance with the reduced tempo while playing the note.

11. A guitar lesson having been recorded on a medium for replay, the recorded lesson comprising:
a first recording of a song including only a guitar portion of a song having been recreated at a tempo reduced in comparison to an original recording of the song, and the song having been divided into different sections and each section having one or more measures and each measure having one or more chords comprising two or more notes;
for each section of the song an audible tablature identification of each note of each chord for each measure in a section of the song, in the identical order in which the sections appear in the song;
each section of the song immediately preceding or following the audible tablature identification of the notes of that section of the song; and, a second recording of the song in which the guitar portions are removed so a student or musician can play along with the recording, and the second recording appearing at an end of the lesson.

12. The recorded guitar lesson of claim 11 further comprising a recording of each note being played after the tablature identification of the note, the note being played in accordance with the reduced tempo.

13. The recorded guitar lesson of claim 11 further comprising a recording of each chord being played after the tablature identification of each note of the chord, the chord being played in accordance with the reduced tempo.

14. The recorded guitar lesson of claim 11 further comprising a recording of each measure of the song being played after the tablature identification of all the notes and chords in each measure.

15. The recorded guitar lesson of claim 11 wherein tablature identification of the notes comprises a letter associated with one of the guitar strings, a letters selected form the group of letters I, M, R, P respective index, middle, ring or pinkie finger on a hand and a number associated with a fret on the neck of the guitar.
